(19) United States
(12) Patent Application Publication
(10) Pub. No.: US 2003/0173545 A1
(43) Pub. Date: Sep. 18, 2003

(54) Composition for antistatic hard coat, antistatic hard coat, process for producing the same, and multilayered film with antistatic hard coat

(76) Inventors: Mamoru Hino, Osaka (JP); Yoshio Nishimura, Osaka (JP)

Correspondence Address: ARMSTRONG,WESTERMAN & HATTORI, LLP, 1725 K STREET, NW, SUITE 1000, WASHINGTON, DC, 20006, US

(21) Appl. No.: 10/240,739

(22) PCT Filed: Apr. 9, 2001
(86) PCT No.: PCT/JP01/03039

(30) Foreign Application Priority Data
Apr. 10, 2000 (JP) 2000-108254

(51) Int. Cl. H01B 1/00

(52) U.S. Cl. 252/500

(57) ABSTRACT

A composition for antistatic hard coats which comprises 100 parts by weight of a polyfunctuinal acrylate and, compounded therewith, 50 to 400 parts by weight of fine conductive particles having a particle diameter of 10 to 30 nm and 10 to 80 parts by weight of at least one silicon compound selected from the group consisting of silica particles surface-treated with an organic substance, organopolysiloxanes, and silicon acrylate; an antistatic hard coat which is formed by curing the composition; a multilayerd film which comprises a base film and formed thereon the antistatic hard coat; and a process for producing an antistatic hard coat which comprises applying the composition to a base film, drying and curing the composition to form an antistatic hard coat, and subjecting the hard coat to either a physical treatment in which the hard coat is treated with, e.g., corona discharge or a chemical treatment in which the surface of the cured coat is corroded with an organic solvent to regulate the amount of silicon element.

### FIELD OF THE INVENTION

This invention relates to a composition for an antistatic hard coat, antistatic hard coat, process for producing the same, and multilayered film with the antistatic hard coat, more particularly a composition for an antistatic hard coat which can be suitably used for displays or the like, having a stable antistatic function, and excellent in surface hardness and adhesion; antistatic hard coat of the same composition; process for producing the same; and multilayered film with the antistatic hard coat.

### BACKGROUND OF THE INVENTION

Recently, the area in which displays are applicable has been continuously expanding to new devices, e.g., in-car navigation system, cellular phones and mobile computers, beyond the conventional uses, e.g., TV and computer monitors. The types are also expanding from the conventional CRT type; for example, LCD and plasma display types are spreading. Their image-displaying sections are frequently provided with a laminate comprising a plastic base coated with hard coat layer of an acrylic compound or the like set by ultraviolet ray (UV) on the upper side and adhesive layer on the lower side (back side), by which the laminate is adhered to the displaying section.

The plastic base by itself has a pencil hardness of B or less (determined in accordance with JIS K-6894) comes to exhibit a pencil hardness of 3H or more, when covered with the hard coat layer.

However, these image-displaying sections in general are easily charged with electricity on the surface, and hence stained to make displayed information more difficult to recognize. Moreover, they are increasingly used outdoors as mobile devices. Information visibility of these devices will be frequently deteriorated further when external light is reflected on the display surface stained with dust.

In order to solve these problems, they are covered with a hard coat incorporated with an ion-conducting material, e.g., alkali metal, inside or on the upper layer to make them antistatic. For example, Japanese Patent Laid-open Publication No.5-339306 discloses a combination of an alkali metal or ammonium salt with an imidazoline-based surfactant to develop an antistatic function.

In the antistatic layer produced by the above method, the ion conductance may not smoothly proceed to greatly deteriorate the antistatic function, unless it is provided as the uppermost layer. It is therefore difficult to coat the antistatic layer with another a layer of additional function, e.g., reflection prevention, or UV or heat ray cutting. Another problem is caused by moisture in air working as a medium for ion conductance, with the result that surface resistance varies with humidity to make the product quality unstable.

Another method to realize the antistatic function is incorporation of the hard coat material or organic binder (fixing agent) containing inorganic electroconductive particles, e.g., those of ATO (tin oxide doped with antimony pentaoxide). It can reduce surface resistance to 10¹¹ Ω/□ or less stably irrespective of humidity of the ambient atmosphere, but involves a disadvantage of reduced hardness of the hard coat, even after it is set by UV or heat, because of lack of compatibility of the organic (hard coat) material with the inorganic particles to make the composite fragile.

A hard coat provided with an antistatic function is normally coated with an inorganic thin film by, e.g., sputtering, vapor deposition, or coating to realize an additional function, e.g., reflection prevention. In such a case, insufficient adhesion of the inorganic thin film to the surface of the hard coat of an organic material may cause peeling-off of a thin tape in the durability test conducted in accordance with JIS D-0202, where the test piece with the tape adhered to the surface cut to have a checked pattern is subjected to the tape-peeling test after being placed in a chamber kept at a high temperature and humidity.

One of the known methods to improve adhesion of an inorganic thin film to the hard coat layer provided with an antistatic function is corona-treatment of the hard coat surface. This method, however, treats only the outermost surface, and hence improves the adhesion to only a limited extent. The corona-treatment for an extended period significantly deteriorates the base surface and will conversely reduce the adhesion.

The other methods include incorporation of amorphous silica particles in an acrylic coating material for the hard coat to improve the adhesion to a metallic thin film (Japanese Patent Laid-open Publication No.5-162261), and use of an organosiloxane resin to improve the adhesion characteristics. These methods, certainly improving surface hardness, are insufficient in the effect of improving adhesion.

It is an object of the present invention to provide a composition for antistatic hard coat simultaneously satisfying stable antistatic function and hard coat function (having a pencil hardness of 3H or more), and, at the same time, highly adhesive to the inorganic thin film or the like having an additional function which is provided on the hard coat. It is another object of the present invention to provide a hard coat of the same material. It is still another object of the present invention to provide a process for producing the same hard coat. It is still another object of the present invention to provide a multilayered film with the same hard coat.

### DISCLOSURE OF THE INVENTION

The inventors of the present invention have found, after having extensively studied to solve the above problems, that a composition of polyfunctional acrylate containing fine electroconductive particles of a specific material and specific silicon-based compound at a specific content gives an antistatic hard coat and multilayered film with the hard coat exhibiting stable antistatic function and, at the same time, excellent in hardness and adhesion, when set and surface-treated, reaching the present invention.

The first aspect of the invention provides a composition for antistatic hard coat which comprises 100 parts by weight of a polyfunctional acrylate (A), and compounded therewith, 50 to 400 parts by weight of fine electroconductive particles (B) having a particle diameter of 10 to 30 nm and 10 to 80 parts by weight of at least one silicon compound (C) selected from the group consisting of silica particles surface-treated with an organic substance, organopolysiloxane and silicon acrylate.

The second aspect of the invention is the composition for antistatic hard coat of the first aspect, wherein the fine electroconductive particles (B) are of ATO and/or ITO.

The third aspect of the invention is the composition for antistatic hard coat of the first aspect, wherein the fine electroconductive particles (B) and silicon compound (C) are incorporated at 200 to 300 parts by weight and 20 to 60 parts by weight, respectively, per 100 parts by weight of the polyfunctional acrylate (A).

The fourth aspect of the invention is the composition for antistatic hard coat of the first aspect which is further incorporated with an optional photo-curing agent or radical initiator.

The fifth aspect of the invention provides an antistatic hard coat formed by setting the composition for antistatic hard coat of one of the first to fourth aspects, wherein the hard coat surface has an elementary composition containing Si at 10 to 35 atomic % on total of Si, C and O.

The sixth aspect of the invention provides a multilayered film with the antistatic hard coat of the fifth aspect which is provided on a base film.

The seventh aspect of the invention provides the multilayered film of the sixth aspect, wherein the base film is coated with an adhesive layer on the side opposite to the antistatic hard coat.

The eighth aspect of the invention provides the multilayered film of the seventh aspect, wherein the adhesive layer is composed of 100 parts by weight of an acrylic polymer and 1 to 20 parts by weight of a silane compound.

The ninth aspect of the invention provides the multilayered film of the sixth or seventh aspect which has a layer having an additional function as the outermost layer.

The tenth aspect of the invention provides the multilayered film of the ninth aspect, wherein the layer having an additional function is an antireflection film, or IR-cutting or UV-cutting filter.

The eleventh aspect of the invention provides a process for producing an antistatic hard coat which is produced by spreading, drying and setting the composition for antistatic hard coat of one of the first to fourth aspects on a base film, and then is subjected to an optional surface treatment selected from the group consisting of physical treatments by corona discharge, plasma discharge, light from a low-voltage mercury lamp and excimer laser beams, and chemical treatment with an organic solvent to erode the set composition surface and thereby to control Si element content.

The twelfth aspect of the invention provides the process of the eleventh aspect, wherein the composition for antistatic hard coat is set by UV or heat.

The thirteenth aspect of the invention provides the process of the eleventh aspect, wherein the surface treatment is effected by corona discharge, plasma discharge or light from a low-voltage mercury lamp.

The fourteenth aspect of the invention provides the process of the thirteenth aspect, wherein the surface treatment is effected under a pressure near atmospheric pressure, in an air and/or noble gas atmosphere, and in an electrical field having a discharge current density of 0.2 to 300 mA/cm² generated in a pair of counter-electrodes.

The fifteenth aspect of the invention provides the process of the fourteenth aspect, wherein a pulsed electrical field is applied to the space between a pair of the counter-electrodes to secure the conditions of voltage rise time of 100 μs or less, pulsed electrical field intensity of in a range from 1 to 100 kV/cm and field frequency of 0.5 to 100 kHz.

### BRIEF DESCRIPTION OF THE DRAWINGS

FIG. 1 describes one example of the silica particle surface-coated by the treatment with an organic substance.

FIG. 2 describes another example of the silica particle surface-coated by the treatment with an organic substance.

FIG. 3 describes one example of waveform of the pulsed voltage applied to the space between a pair of counter-electrodes.

### PREFERRED EMBODIMENTS OF THE INVENTION

The present invention is described in more detail.

1. Polyfunctional Acrylate (A)

The polyfunctional acrylate (A) is not limited. Those acrylates useful for the present invention include pentaerythritolhexa (meth) acrylate, dipentaerythritolhexa (meth) acrylate, pentaerythritolpenta (meth) acrylate, dipentaerythritolpenta (meth) acrylate, pentaerythritol tetra (meth) acrylate, dipentaerythritol tetra (meth) acrylate, pentaerythritol tri (meth) acrylate, dipentaerythritol tri (meth) acrylate, pentaerythritolglycidyl (meth) acrylate, trimethylolpropane tri (meth) acrylate, and derivatives and modifications thereof, wherein the term “(meth)acrylate” in this specification means that it may be either acrylate or methacrylate.

The polyfunctional acrylates (A) also include a mixture of dipentaerythritolpenta (meth) acrylate and dipentaerythritolhexa (meth) acrylate (e.g., Nippon Kayaku's DPHA) and urethane-based polyfunctional acrylate as the modification.

These compounds may be used either individually or in combination.

2. Fine Electroconductive Particles (B)

The materials for the fine electroconductive particles for the present invention include ATO (indium oxide doped with antimony pentaoxide), ITO (indium oxide doped with tin dioxide), Sb₂O₅, TiO₂ and ZnO₂, of which ATO and ITO are more preferable. They may be used either individually or in combination.

The fine electroconductive particles necessarily have a particle diameter controlled in a range from 10 to 30 nm, preferably 15 to 25 nm. The particles having a diameter below 10 nm may reduce light ray transmittance of the antistatic hard coat in which they are incorporated and limit applicability of the product. The diameter above 30 nm is also undesirable, because of increased haze of the hard coat.

The fine electroconductive particles are incorporated preferably at 50 to 400 parts by weight per 100 parts by weight of the polyfunctional acrylate (A), more preferably 200 to 300 parts by weight. At a content below 50 parts by weight, the desired antistatic function may not be secured, because of possible disconnection of the electroconductive paths for the particles. At a content above 400 parts by weight, on the other hand, the hard coat in which they are incorporated may have deteriorated functions, because of insufficient light ray transmittance (or excessive haze) and increased fragility.

3. Silicone-Based Compound (C)

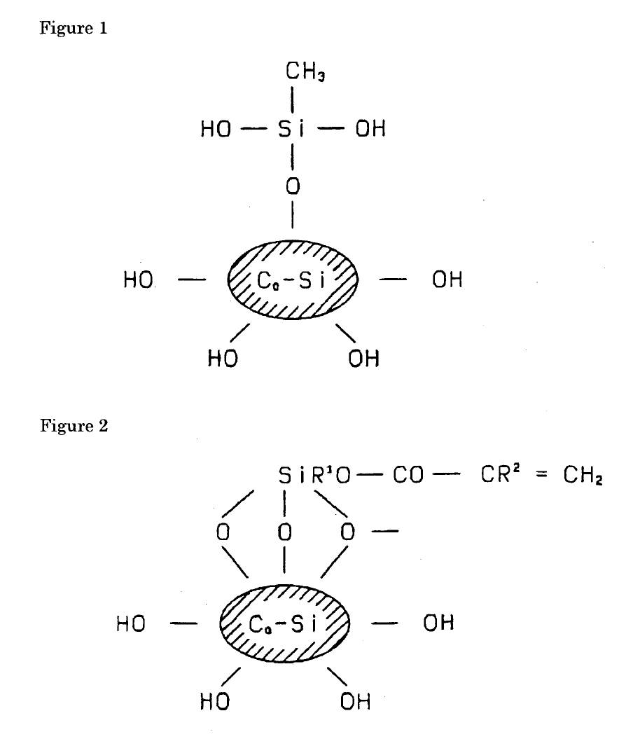

The silicon compound (C) for the present invention is selected from the group consisting of silica particles surface-treated with an organic substance, organopolysiloxane and silicon acrylate. The examples of the silica particles surface-treated with an organic substance are schematically illustrated in FIGS. 1 and 2, where Co—Si means colloidal silica, and R¹ and R² in FIG. 2 are each an alkyl group, which may be the same or different. These silica particles surface-treated with an organic substance include Toshiba Silicone's UVHC-1103 and UVHC-1105.

The silicon particles surface-treated with an organic substance having an excessively small particle diameter will increase viscosity of the composition before setting, in which they are incorporated, to make the antistatic hard coat difficult to form. On the other hand, those having an excessively large particle diameter may deteriorate transparency of the antistatic hard coat, because of decreased haze. Therefore, they normally have a particle diameter of preferably 0.1 to 3 μm, more preferably 0.2 to 0.7 μm.

The organopolysiloxanes useful for the present invention include those having one of the following structures:

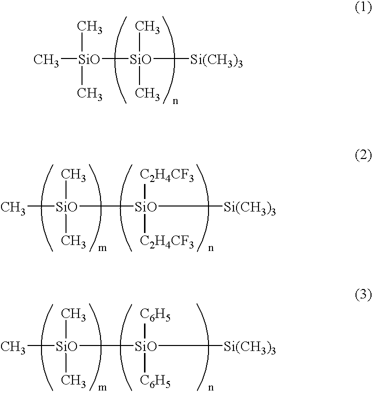

wherein, “m” and “n” are each an integer of 0 or more, preferably satisfying the relationships “m” 0, “n” 0 and 10≦“m+n” 100, more preferably 15≦m+n≦50. When “m+n”<10, the antistatic hard coat may have deteriorated functions, because of decreased hardness. When “m+n”>100, on the other hand, the antistatic hard coat may be difficult to form, because of increased viscosity of the composition before setting.

The silicon acrylates useful for the present invention are represented by the general formula (CH₃O)₃SiR³O—CO—CR⁴═CH₂, wherein R³ and R⁴ are each an alkyl group, which may be the same or different.

The silicon-based compound (C) is incorporated at 10 to 80 parts by weight per 100 parts by weight of the polyfunctional acrylate (A), preferably 20 to 60 parts by weight. At a content of below 10 parts by weight, the antistatic hard coat may have a surface hardness insufficient to improve adhesion. At above 80 parts by weight, on the other hand, the antistatic hard coat may be cracked after being set, and have decreased adhesion to the film of additional function to be provided thereon.

4. Other Components

The composition for antistatic hard coat of the present invention may be incorporated with a solvent as a diluent to adjust its viscosity before setting. The solvent is not limited, so long as it is not polymerizable. The solvents useful for the present invention include methylethylketone, toluene, xylene, ethyl acetate, butyl acetate, methyl cellosolve, ethyl cellosolve, ethyl cellosolve acetate, isopropyl alcohol and diacetone alcohol. They may be used either individually or in combination.

The composition for antistatic hard coat of the present invention may be further incorporated with an initiator, photo-curing agent or the like to accelerate setting of the composition. The additive is not limited, so long as it can initiate and accelerate polymerization of the acryloyl group present in the polyfunctional acrylate (A).

For example, a known photo-polymerization initiator (photo-curing agent) may be used, when the composition is cured with UV. The representative initiators include 2,2-dimethoxy-2-phenylacetophenone, acetophenone, benzophenone, xanthone, 3-methylacetophenone, 4-chlorobenzophenone, 4,4′-dimethoxybenzophenone, benzoinpropyl ether, benzyldimethylketal, N,N,N′,N′-tetramethyl-4,4′-diaminobenzophenone, 1-(4-isopropylphenyl)-2-hydroxy-2-methylpropan-1-one, and other thiooxanthone-based compounds.

A known initiator (radical initiator) may be used, when the composition is thermally set. The representative initiators include ketone peroxide, peroxyketal, hydroperoxide, dialkyl peroxide, diacyl peroxide and peroxy-dicarbonate. These initiators may be used either individually or in combination.

The composition for antistatic hard coat of the present invention may be further incorporated with one or more other additives, e.g., pigment, filler, surfactant, dispersant, plasticizer, UV absorber and antioxidant, within limits not harmful to the object of the present invention. These additives may be used either individually or in combination.

5. Antistatic Hard Coat

The antistatic hard coat of the present invention is formed by setting the composition comprising the polyfunctional acrylate (A), fine electroconductive particles (B) and silicon compound (C), as described earlier. The hard coat may be formed on a base film.

The material for the base film is not limited, so long as it is transparent. The materials useful for the base film include polyethylene, polypropylene, polyester, recycled cellulose, diacetyl cellulose, triacetyl cellulose, polyvinyl chloride, polyvinylidene chloride, polyvinyl alcohol, polystyrene, polyethylene terephthalate (PET), polycarbonate (PC), polyimide and nylon, of which triacetyl cellulose, polyethylene terephthalate (PET) and polycarbonate are more preferable for their high transparency.

For production of the antistatic hard coat of the present invention, it is preferable to spread, dry and set the above-described composition for hard coat on a base film. For producing the composition for hard coat before setting, the polyfunctional acrylate (A), fine electroconductive particles (B) and silicon compound (C) may be spread individually in any order or in the form of mixture, or in combination of the two arbitrarily selected components.

The above-described composition may be spread on a base film by a known method, e.g., spray coating, gravure coating, roll coating or bar coating. Quantity of the composition to be spread is adjusted to have a desired film thickness, determined in consideration of the required properties.

The method for setting the composition spread and dried on a base film is not limited. It may be set by a known method, e.g., by the aid of UV or heat.

When the composition is irradiated with UV for setting, the energy sources useful for the present invention include a high-voltage mercury lamp, halogen lamp, xenon lamp, nitrogen laser, electron beam accelerator and device for emitting radioactive element. Dose of the energy ray is preferably 50 to 5000 mJ/cm² as the cumulative exposure as the UV of 365 nm in wavelength. At a dose below 50 mJ/cm², the antistatic hard coat may have decreased wear resistance and hardness, due to insufficient setting. At above 5000 mJ/cm², on the other hand, the hard coat may be colored to lose transparency.

It is necessary for the antistatic hard coat of the present invention to have a surface elementary composition containing Si at 10 to 35 atomic % on total of Si, C and O, after it is set (the set composition is hereinafter referred to as the “set article.”). The surface Si content is determined by ESCA as Si quantity/(Si+C+O quantities).

When the set article surface has an elementary composition containing Si at below 10 atomic %, it may have insufficient adhesion to the film of additional function to be provided thereon, because of decreased ratio of —SiO— exposed to the surface. At above 35 atomic %, on the other hand, the antistatic hard coat may be cracked also to have decreased adhesion to the film of additional function to be provided thereon. The Si content is preferably in a range from 11 to 30 atomic %.

The set article surface means the area to a depth of about 50 to 1500 nm from the outermost surface, preferably about 100 to 800 nm.

The antistatic hard coat is preferably 1 to 15 μm thick, more preferably 2 to 8 μm. When thinner than 1 μm, it may have decreased hardness. When thicker than 15 μm, on the other hand, it may be cracked to have decreased adhesion to the film of additional function to be provided thereon.

6. Process for Producing the Antistatic Hard Coat

The method for keeping the Si content at 10 to 35 atomic % in the elementary composition on the set article surface for the present invention is not limited, so long as it has the effects of mild etching of the set article surface and exposing the —SiO— bond. The methods useful for the present invention include physical treatments, e.g., those by corona discharge, plasma discharge, light from a low-voltage mercury lamp and excimer laser beams, and chemical treatment, e.g., those with an organic solvent to erode the set article surface and thereby to control Si element content, of which the treatments by corona discharge, plasma discharge and light from a low-voltage mercury lamp are more preferable for their high efficiency.

The surface-treated depth is not limited, so long as it causes no damage on the set article, preferably around 50 to 1500 nm, more preferably 100 to 800 nm. When treated to a depth below 50 nm, the surface may not have sufficient adhesion, because of insufficient quantity of the —SiO— bond formed. On the other hand, the surface treatment to a depth above 1500 nm may cause a significant damage on the base, possibly separating the film of additional function from the antistatic hard coat on which it is provided at the interface between them.

In the process of the present invention for producing the antistatic hard coat, pressure near atmospheric pressure means 1.33×10⁴ to 10.64×10⁴ Pa, preferably 9.31×10⁴ to 10.37×10⁴ Pa for ease of pressure control and simplification of the system structure.

The surface treatment for the present invention is preferably effected in an air and/or noble gas atmosphere. The noble gases useful for the present invention include helium, neon, argon, xenon and nitrogen, of which argon is more preferable, because the surface can be treated more mildly than in an air atmosphere.

When discharge current density between the counter-electrodes is an excessively low level, improvement of adhesion of the hard coat is difficult to expect, because the surface may not be treated partly. When it is an excessively high level, on the other hand, hard coat may have decreased adhesion, because of possible decomposition of the organic compound on the surface. Therefore, it is preferably in a range from 0.2 to 300 mA/cm² for the present invention, more preferably 5 to 200 A/cm².

Discharge current density between the counter-electrodes for the present invention means the current flowing between the electrodes divided by the area perpendicular to the current flow direction in the discharge space. It is equivalent to the current divided by the electrode area, when the counter-electrodes are flat plates running in parallel to each other.

When a pulsed electrical field is applied to the space between the electrodes, pulse current flows between these electrodes. In such a case, discharge current density is the maximum pulse current, i.e., the peak-to-peak value, divided by the above-described area.

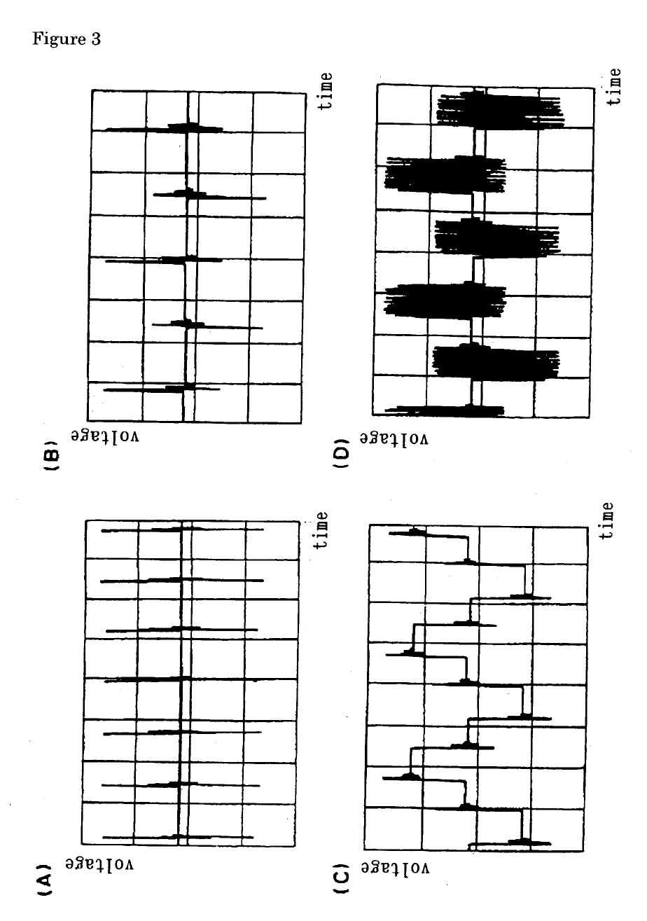

When a pulsed electrical field is applied to the space between the electrodes in the present invention, the hard coat surface can be evenly treated mildly in a shorter time by use of a pulse waveform in place of alternating current waveform. The pulse waveform is not limited. For example, it may be an impulse type as shown in FIG. 3(A) or (B), square type as shown in FIG. 3(C), or modulated type as shown in FIG. 3(D). FIG. 3 gives the waveform examples in which applied voltage is alternating between positive and negative signs. However, the voltage waveform may be of one polarity, positive or negative.

In the present invention, the pulse voltage to be applied to the space between the electrodes can dissociate the gas more efficiently for generating a plasma, as pulse rise and fall time decrease. Therefore, rise time of the pulse voltage to be applied to the space between the electrodes is preferably 100 μs or less, more preferably 10 μs or less. When rise time exceeds 100 μs, the discharge condition tends to move to arc discharge and become unstable. A pulsed electrical field rising in a shorter time brings an effect of realizing a discharge condition of higher electron density.

Fall time of pulse voltage is not specified. However, pulse voltage preferably falls as quickly as it rises. More preferably, it is 100 μs or less.

The upper limit of rise or fall time is not limited, but 40 μs or more is practical in consideration of power source device or the like.

Rise time used in this specification is defined as a time period for which direction of voltage change is continuously positive, and fall time as a time period for which direction of voltage change is continuously negative.

The pulsed electrical field having an excessively low intensity may cause too uneven discharge to uniformly effect the surface treatment. On the other hand, the field having an excessively high intensity may damage the hard coat surface, preventing it from having improved adhesion to the film of additional function to be provided thereon. Therefore, it is preferably in a range from 1 to 100 kV/cm, more preferably 5 to 60 kV/cm.

The pulsed electrical field to be generated between the electrodes may be modulated, as required, for its pulse waveform, rise and fall time, and frequency.

The pulsed electrical field having a higher frequency and shorter pulse width is more suitable for high-speed treatment.

The pulsed electrical field to be applied to the space between the counter-electrodes may cause too uneven discharge to uniformly effect the surface treatment, when it has an excessively low frequency. On the other hand, the field having an excessively high frequency may damage the hard coat surface, preventing it from having improved adhesion to the film of additional function to be provided thereon. Therefore, it is, in general, preferably in a range from 0.5 to 100 kHz, more preferably 2 to 40 kHz.

The pulsed electrical field preferably has a pulse duration period of 1 to 1000 μs, more preferably 3 to 200 μs. Discharge may be unstable when it lasts for less than 1 μs. The discharge condition tends to move to arc discharge, when it lasts for more than 1000 μs.

The set article surface can be sufficiently treated at room temperature, although it may be heated or cooled prior to the surface treatment.

7. Multilayered Film with the Antistatic Hard Coat

The multilayered film with the antistatic hard coat of the present invention may include an adhesive layer on the antistatic hard coat via a base film. The base film may be of the material described earlier.

The adhesive layer is preferably of the material which can fast bond the base film or antistatic hard coat to the optical part, e.g., glass or plastic, on which it is mounted, and little foams even under high temperature and humidity conditions. An acrylic-based adhesive agent is one of the suitable examples for the adhesive layer, more preferably it is composed of 100 parts by weight of an acrylic polymer and 1 to 20 parts by weight of a silane compound.

The acrylic polymers useful for the adhesive layer include an acrylic-based copolymer containing an alkyl (meth) acrylate as the major ingredient.

The alkyl (meth) acrylates include ethyl (meth) acrylate, n-propyl (meth) acrylate, isopropyl (meth) acrylate, n-butyl (meth) acrylate, isobutyl (meth) acrylate, sec-butyl (meth) acrylate, t-butyl (meth) acrylate, pentyl (meth) acrylate, hexyl (meth) acrylate, 2-ethylhexyl (meth) acrylate, n-octyl (meth) acrylate, isooctyl (meth) acrylate, n-nonyl (meth) acrylate, isononyl (meth) acrylate, lauryl (meth) acrylate, acetyl (meth) acrylate and stearyl (meth) acrylate. These compounds may be used either individually or in combination.

The acrylic-based copolymer containing an alkyl (meth) acrylate at an insufficient content may have an excessive cohesive force and be difficult to realize a sufficient pressure-sensitive adhesive strength. At an excessively high content, on the other hand, the cohesive force may be too low to secure a sufficient shear strength. The copolymer, therefore, preferably contains the alkyl (meth) acrylate at 50 to 98% by weight, more preferably 70 to 95% by weight.

The acrylic-based copolymer may contain a copolymerized vinyl-based monomer, as required. These monomers useful for the present invention include vinyl monomers having a carboxyl group, e.g., (meth) acrylic acid, itaconic acid, crotonic acid, (anhydrous) maleic acid, (anhydrous) fumaric acid and a carboxy alkyl (meth) acrylate (e.g., carboxyethyl acrylate); vinyl monomers having a hydroxyl group, e.g., 2-hydroxyethyl (meth) acrylate, 2-hydroxypropyl (meth) acrylate, 4-hydroxybutyl (meth) acrylate, caprolactone-modified (meth) acrylate, polyethylene glycol (meth) acrylate and polypropylene glycol (meth)acrylate; nitrogen-containing vinyl monomers, e.g., (meth)acrylonitrile, N-vinyl pyrrolidone, N-vinyl caprolactam, N-vinyl laurolactam, (meth)acryloyl morpholine, (meth)acrylamide, dimethyl (meth)acrylamide, N-methylol (meth)acrylamide, N-butoxymethyl (meth)acrylamide, dimethylaminopropyl (meth)acrylamide, dimethylaminomethyl (meth) acrylate, dimethylaminoethyl (meth) acrylate, dimethylaminopropyl (meth) acrylate and dimethylaminoethyl (meth) acrylate; and vinyl acetate, vinyl pivalate, vinyl propionate, styrene and isobornyl (meth)acrylate. These compounds may be copolymerized either individually or in combination.

The acrylic-based copolymer containing a copolymerized vinyl-based monomer at an insufficient content may have an excessively low cohesive force and be difficult to realize a sufficient shear strength. At an excessively high content, on the other hand, the cohesive force may be too high to secure a sufficient pressure-sensitive adhesive strength. The copolymer, therefore, preferably contains the copolymerized vinyl-based monomer at 2 to 50% by weight, more preferably 5 to 30% by weight.

The acrylic-based copolymer is preferably produced by solution polymerization, because of its controllability of the polymerization reactions. A thermal polymerization initiator is normally used, when solution polymerization is adopted.

The thermal polymerization initiators useful for the present invention include organic peroxides, such as ketone peroxides, e.g., methylethylketone peroxide, methylisobutylketone peroxide and cyclohexanone peroxide; diacyl peroxides, e.g., isobutyryl peroxide, benzoyl peroxide, 2,4-dichlorobenzoyl peroxide and P-chlorobenzoyl peroxide; hydroperoxides, e.g., diisopropylbenzene hydroperoxide and t-butyl hydroperoxide; dialkyl peroxides, e.g., 2,5-dimethyl-2,5-di(t-butylperoxy)hexane, 1,3-bis-(t-butylperoxyisopropyl)benzene and di-t-butyl peroxide; peroxy ketals, e.g., 1,1-di-(t-butylperoxy)-3,3,5-trimethylcyclohexane and 1,1-di-(t-butylperoxy)cyclohexane; and percarbonate, e.g., t-butylperoxypivalate, t-butylperoxy-2-ethylhexanoate, t-butylperoxydicarbonate, and bis-(4-t-butylcyclohexyl)peroxydicarbonate. Those useful for the present invention also include azobis-based compounds, e.g., 2,2′-azobis-isobutylonitrile, 2,2′-azobis-2-methylbutylonitrile, 2,2′-azobis-2,4-dimethylvaleronitrile, 1,1′-azobis-1-cyclohexanecarbonitrile, dimethyl-2,2′-azobisisobutyrate, 4,4′-azobis-4-cyanovaleric acid and 2,2′-azobis-(2-aminopropane) dihydrochloride.

The system for polymerizing the acrylic-based copolymer may be incorporated with a chain transfer agent, to control fluctuations of the polymerization reactions and adequately adjust molecular weight of the copolymer produced. The chain transfer agents useful for the present invention include thiol compounds, e.g., n-dodecyl mercaptan, 2-mercaptoethanol, β-mercaptopropionic acid, octyl-β-mercaptopropionate, methoxybutyl β-mercaptopropionate, trimethylolpropanetris (β-thiopropionate), butyl thioglycolate, propane thiols, butane thiols and thiophosphites; and halogen compounds, e.g., carbon tetrachloride.

The acrylic-based copolymer produced by the above polymerization method preferably has a weight-average molecular weight of 800,000 or more, more preferably 1,000,000 or more, because it may be difficult to realize sufficient stress relaxation when its molecular weight is insufficient.

The acrylic-based copolymer may be crosslinked in the presence of a crosslinking agent. Any crosslinking agent may be used for the present invention, so long as it is reactive with a polar group in an acrylic-based copolymer which is used for a common solvent-type adhesive agent. The crosslinking agents useful for the present invention include isocyanate-based ones, e.g., tolylene diisocyanate (TDI), naphthylene-1,5-diisocyanate, diphenylmethane diisocyanate (MDI), hexamethylene diisocyanate (HMDI), isophorone diisocyanate (IPDI), xylene diisocyanate (XDI) and trimethylolpropane-modified TDI; epoxy-based ones, e.g., ethylene glycol diglycidyl ether, propylene glycol diglycidyl ether and 1,6-hexanediol diglycidyl ether; and aziridine-based ones, e.g., N,N-hexamethylene-1,6-bis(1-aziridine carboxyamide).

The silane compounds useful for the other component of the adhesive agent include alkoxy silanes, e.g., methyltrimethoxysilane, methyltriethoxysilane, ethyltrimethoxysilane, ethyltriethoxysilane, dimethyldimethoxysilane, dimethyldiethoxysilane, phenyltrimethoxysilane, phenyltriethoxysilane, diphenyldimethoxysilane, diphenyldiethoxysilane, isobutyltrimethoxysilane and isobutyltriethoxysilane; chlorosilanes, e.g., methyltrichlorosilane, ethyltrichlorosilane, dimethylchlorosilane, diethyldichlorosilane, trimethylchlorosilane, triethylchlorosilane, phenyltrichlorosilane and diphenyldichlorosilane; and methyl hydrogen silicone.

The adhesive layer for the present invention is preferably of the material which can fast bond the base film to the glass or plastic plate on which the antistatic hard coat is mounted, and shows excellent re-peeling property even after being left in a high-temperature (80° C.) and high-humidity (60° C.×95%) atmosphere. The adhesive layer is preferably composed of 100 parts by weight of the acrylic polymer incorporated with 1 to 20 parts by weight of the silane compound. At an insufficient silane compound content, it may have deteriorated re-peeling property. At an excessive content, it tends to exfoliate due to insufficient adhesive strength. Therefore, it preferably has the above composition, more preferably it is composed of 100 parts by weight of the acrylic polymer incorporated with 3 to 10 parts by weight.

The adhesive agent for the adhesive layer for the present invention may be incorporated with a tackifying resin, as required, within limits not harmful to the optical characteristics, e.g., transparency.

The tackifying resins useful for the present invention include C5 or C9 based-petroleum resin, rosin resin, rosin ester resin, terpene resin, terpene/phenol resin, coumarone/indene resin, disproportionated rosin ester resin, polymerized rosin resin, polymerized rosin ester resin, xylene resin, styrene resin, and hydrogenated products thereof. They may be used either individually or in combination.

The tackifying resin constitutes an uncrosslinked portion in the adhesive agent, and will deteriorate cohesive force of the agent and hence prevent resistance to heat and moisture from being fully exhibited, when incorporated at an excessively high content. It is therefore preferably incorporated at 30 parts by weight or less per 100 parts by weight of the acrylic polymer.

The adhesive layer having an insufficient thickness may lose its adhesive strength to the glass or plastic plate on which the antistatic hard coat is mounted, and tends to be broken at the interface under a high-temperature, high-humidity condition by the stress caused by thermal shrinkage. The adhesive layer having an excessive thickness is also undesirable, because of increased residual solvent in the adhesive agent, which will foam at high temperature. The thickness, therefore, is preferably in a range from 5 to 35 μm, more preferably 10 to 30 μm.

The antistatic hard coat for the multilayered film of the present invention may be coated with a film of additional function as the outermost layer.

The film of additional function is not limited, and may be an antireflection film, or IR-cutting or UV-cutting filter.

The film type and compound(s) used therefor vary depending on specific purposes. The compounds normally used for such films include metallic compounds, e.g., TiO₂, SiO₂, ZrO₂ and MgF₂; and metallic elements, e.g., Au, Ag, Cu and Pt.

Thickness of the film of additional function is not limited, and varies depending on specific purposes or objects. In general, it is preferably in a range from 5 to 300 nm, when the film is used as an optical part.

The method for producing the film of additional function is not limited. It may be produced by sputtering, vapor deposition, CVD, coating or the like.

In the multilayered film of the present invention with the antistatic hard coat, the antistatic hard coat, which may be coated with a film of additional, function, may be further coated with a stain-proofing layer, as required. Such a layer is preferably water- and oil-repellant to make the multilayered film well cleanable, because oil stain, in particular that caused by fingerprints, can be easily wiped out. Those suitable for the present invention have a contact angle of 80° or more for water-repellency, and 50° or more for oil-repellency.

The layer having the above characteristics is incorporated with, e.g., a fluorine-based silane coupling agent, long-chain alkyl-based silane coupling agent or the like.

### PREFERRED EMBODIMENTS

The present invention is described in more detail by EXAMPLES and COMPARATIVE EXAMPLES, which by no means limit the present invention. The properties of the antistatic hard coat films prepared in EXAMPLES and COMPARATIVE EXAMPLES were determined by the following evaluation methods.

### Evaluation Methods

(1) Surface Si Element Content

The surface Si element content of the surface-treated antistatic hard coat layer was determined by ESCA as Si quantity/(Si+C+O quantities)(%).

(2) Pencil Hardness

Pencil hardness of the antistatic hard coat film was determined in accordance with JIS K-6894, where the film was evaluated to be good, when it showed no lead scars at least 3 out of 5 times it was scratched by a pencil (in Table 2, “3H5/5” means that the film showed the lead-caused scar in no case, when it was scratched 5 times by a pencil having a hardness of 3H).

(3) Resistance to Scratching

The antistatic hard coat film was rubbed 30 times by steel wool (#0000) under a pressure of 200 g/cm². It was evaluated to be good and marked with o, when it showed no scar, and otherwise it was marked with x.

(4) Tape Peeling Test

a) Resistance of the durability-tested hard coat film to peeling: Tested 1000 hours after the treatment under the conditions of 60° C. and 95% RH

b) Resistance of the UV-treated hard coat film to peeling: Tested 300 hours after the treatment with UV (fade meter)

The antistatic hard coat film, subjected to each of the durability tests a) and b), was cut by a cutter knife to have a checked pattern with 100 1 by 1 mm blocks on the surface, and subjected to the tape peeling test in accordance with JIS D-0202. Number of the blocks kept attached to the tested film was counted (the tested piece with the antireflection layer sufficiently high in adhesive strength to remain on the piece is marked with, e.g., 100/100).

(5) Measurement of Surface Resistance

The antistatic hard coat (10 by 10 cm) surface was measured for resistance 5 times by a 2-point surface resistance meter (Toyo Electronic's HI-Resistance Tester Model TR-3), and the averaged value was reported (a value of, e.g., 3.0×10⁷ Ω/□ is reported as 3.0E+07 Ω/□ in Table 1).

(6) Measurement of Peel Strength of the Adhesive Layer Subjected to Heat Resistance Test

The antistatic hard coat film provided with an adhesive layer was put on a glass plate and tested at 80° C. for 1000 hours for resistance to heat. The assembly was left under the conditions 23° C. and 50% RH for 24 hours to make these parts fit each other, and cut to have the 25 mm wide test piece. It was then subjected to the peel strength test using a tensile tester at a rate of 300 mm/min in the 90° direction. The test piece showing good re-peeling property with the adhesive layer not left on the glass plate is marked with o.

### EXAMPLE 1

### Preparation of the Antistatic Hard Coat

A mixed solution of 100 parts by weight of a polyfunctional acrylate (Nippon Kayaku's DPHA), 45 parts by weight of a paint of surface-treated colloidal silica (GE Toshiba Silicone's UVHC-1105) and 300 parts by weight of ATO (average particle size 20 nm: 15 to 25 nm) as the fine electroconductive particles was diluted with methylethylketone to have the composition containing the above mixed solution at 55%.

The composition was spread on one side of a transparent PET film (Teijin's PET, OFW-188) as the base film by a microgravure coater, and dried under heating. It was then irradiated with UV at 300 mJ/cm², emitted from a UV lamp, to prepare a 5 μm thick antistatic hard coat.

### Surface Treatment

The antistatic hard coat surface was treated by corona discharge using wire electrodes under conditions of pulsed electrical field intensity: 15 kV/cm, frequency: 6 kHz, pulse rise time: 5 μs and discharge current density: 4.5 mA/cm².

The antistatic hard coat surface treated by corona discharge was analyzed by ESCA to determine the surface Si content, defined as Si quantity/(Si+C+O quantities). The surface-treated hard coat had a surface Si content of 15 atomic %. This compared with 9 atomic % before the treatment.

### Formation of the Thin Inorganic Layer

The surface-treated antistatic hard coat was coated with a SiO₂ film to a thickness of 350 nm by sputtering. The SiO₂-coated film is hereinafter referred to as the antistatic hard coat film. Its properties were measured by the above methods. The evaluation results are given in Table 1.

### EXAMPLE 2

The antistatic hard coat film was prepared in the same manner as in EXAMPLE 1, except that ATO was replace by 250 parts by weight of ITO. Its properties were measured by the above methods. The evaluation results are given in Table 1.

### EXAMPLE 3

The antistatic hard coat film was prepared in the same manner as in EXAMPLE 1, except that the corona treatment was replaced by treatment for 30 seconds with light from a low-voltage mercury lamp (which generates strong spectral light ray at 184.9 and 253.7 nm) operating under the conditions of power: 20W, voltage: 56V and current: 0.375A. Its properties were measured by the above methods. The evaluation results are given in Table 1.

### EXAMPLE 4

### Preparation of the Adhesive Layer

48.8 parts by weight of 2-ethylhexyl acrylate, 46 parts by weight of n-butyl acrylate, 5 parts by weight of acrylic acid, 0.2 parts by weight of 2-hydroxyethyl methacrylate, 0.03 parts by weight of n-dodecyl mercaptan and 100 parts by weight of ethyl acetate were mixed with each other uniformly with stirring in a 5-mouthed separable flask equipped with a thermometer, stirrer, reflux condenser, nitrogen inlet nozzle and funnel. The flask was purged with a nitrogen gas under heating for 30 minutes to remove dissolved oxygen from the system. Then, an initiator solution composed of 0.03 parts by weight of benzoyl peroxide dissolved in 3 parts by weight of ethyl acetate was added to the mixture dropwise through the funnel, and the polymerization reactions were allowed to proceed for 15 hours in a nitrogen atmosphere, to produce an acrylic-based copolymer having a weight-average molecular weight of 900,000 determined by GPC. On completion of the reactions, the effluent was diluted with ethyl acetate, to produce an acrylic-based copolymer solution containing the solids at 40% by weight.

Then, the solution was incorporated with 1.0 parts by weight of trimethylolpropane-modified TDI (Nippon Polyurethane Industry's Coronate L, solid content: 45% by weight) as a crosslinking agent and 5 parts by weight of methyl hydrogen silicone (Shin-Etsu Silicone's KF-99) as a silicone compound per 100 parts by weight the solids in the acrylic-based copolymer, to produce the adhesive agent.

The adhesive agent thus prepared was spread on the PET film side of the antistatic hard coat film prepared in EXAMPLE 1, and dried at 100° C. for 5 minutes in an oven, to prepare the antistatic hard coat film coated with the 25 μm thick adhesive layer.

The antistatic hard coat film coated with the adhesive layer was left for a week and cut into a sheet 100 by 100 mm in size, which was put on a glass plate by a laminator with care to prevent bubbles from entering the interface with the laminate. Its properties were measured by the above methods. The evaluation results are given in Table 1.

### EXAMPLE 5

The antistatic hard coat film coated with the adhesive layer was prepared in the same manner as in EXAMPLE 4, except that quantity of the methyl hydrogen silicone used for the adhesive agent was increased to 10 parts by weight. Its properties were measured by the above methods. The evaluation results are given in Table 1.

### EXAMPLE 6

The antistatic hard coat film coated with the adhesive layer was prepared in the same manner as in EXAMPLE 4, except that quantity of the methyl hydrogen silicone used for the adhesive agent was increased to 15 parts by weight. Its properties were measured by the above methods. The evaluation results are given in Table 1.

### COMPARATIVE EXAMPLE 1

The antistatic hard coat film was prepared in the same manner as in EXAMPLE 1, except that it was not surface-treated. Its properties were measured by the above methods. The evaluation results are given in Table 1.

### COMPARATIVE EXAMPLE 2

The antistatic hard coat film was prepared in the same manner as in EXAMPLE 1, except that quantity of ATO as the fine electroconductive particles was decreased to 40 parts by weight. Its properties were measured by the above methods. The evaluation results are given in Table 1.

### COMPARATIVE EXAMPLE 3

The antistatic hard coat film was prepared in the same manner as in EXAMPLE 1, except that 120 parts by weight of a paint containing surface-treated colloidal silica (GE Toshiba Silicone's UVHC-1105) was used. The surface Si content of the film surface-treated by corona discharge was 45 atomic %. Its properties were measured by the above methods. The evaluation results are given in Table 1.

### COMPARATIVE EXAMPLE 4

The antistatic hard coat film was prepared in the same manner as in EXAMPLE 1, except that pulsed electrical field intensity as one of the surface treatment conditions was changed to 0.5 kV/cm. Its properties were measured by the above methods. The evaluation results are given in Table 1.

TABLE 1

| | | | | COMPA- | COMPA- | COMPA- | COMPA- |
|---|---|---|---|---|---|---|---|
| | | | | RATIVE | RATIVE | RATIVE | RATIVE |
| | EXAMPLE | EXAMPLE | EXAMPLE | EXAMPLE | EXAMPLE | EXAMPLE | EXAMPLE |
| | 1 | 2 | 3 | 1 | 2 | 3 | 4 |
| Surface Si | 15 | 15 | 15 | 9 | 15 | 45 | 15 |
| content | | | | | | | |
| Pencil | 3H 4/5 | 3H 5/5 | 3H 4/5 | 3H 5/5 | 3H 4/5 | 3H 3/5 | 3H 4/5 |
| hardness | | | | | | | |
| Resistance | ∘ | ∘ | ∘ | X | ∘ | X | ∘ |
| to | | | | | | | |
| scratching | | | | | | | |
| Resistance | 100/100 | 100/100 | 100/100 | 10/100 | 100/100 | 40/100 | 20/100 |
| to peeling, | | | | | | | |
| durability- | | | | | | | |
| tested hard | | | | | | | |
| coat film | | | | | | | |
| Resistance | 100/100 | 100/100 | 100/100 | 35/100 | 100/100 | 50/100 | 30/100 |
| to peeling, | | | | | | | |
| UV-treated | | | | | | | |
| hard coat | | | | | | | |
| film | | | | | | | |
| Surface | 3.0E+07 | 5.0E+05 | 3.0E+07 | 2.0E+07 | 1E+12 | 1.0E+08 | 3.0E+07 |
| resistance | | | | | or more | | |

| | EXAMPLE 4 | EXAMPLE 5 | EXAMPLE 6 |
|---|---|---|---|
| Peel strength of the adhesive | 2 | 1.54 | 0.6 |
| layer subjected to heat | | | |
| resistance test (kg/2.54 cm) | | | |
| Re-peeling, observed or not | ∘ | ∘ | ∘ |

### INDSUTRIAL APPLICABILITY

The present invention provides an antistatic hard coat having an antistatic function and excellent in surface hardness, because it has the above-described composition. The antistatic hard coat can be greatly improved in adhesion to the film of additional function to be provided thereon and surface hardness, when surface-treated in such a way to have an elementary composition containing Si at 10 to 35 atomic % on total of Si, C and O. Moreover, it can exhibit highly stable antistatic function, when incorporated with fine electroconductive particles of ATO and/or ITO. It can also allow an optical part, e.g., that of glass, to be fast adhered thereto, when provided with an adhesive layer via the base film.

The process of the present invention for producing an antireflection film for displays involves discharge treatment under the above-described conditions to allow its antistatic hard coat and thin inorganic film to fast adhere to each other, and allows the discharge treatment, which has been effected under a low pressure (under a vacuum), to be achieved at near atmospheric pressure for a shorter time.

What is claimed is:

1. A composition for antistatic hard coat which comprises 100 parts by weight of a polyfunctional acrylate (A), and compounded therewith, 50 to 400 parts by weight of fine electroconductive particles (B) having a particle diameter of 10 to 30 nm and 10 to 80 parts by weight of at least one silicon compound (C) selected from the group consisting of silica particles surface-treated with an organic substance, organopolysiloxane and silicon acrylate.

2. The composition for antistatic hard coat according to claim 1, wherein said fine electroconductive particles (B) are of ATO and/or ITO.

3. The composition for antistatic hard coat according to claim 1, wherein said fine electroconductive particles (B) and silicon compound (C) are incorporated at 200 to 300 parts by weight and 20 to 60 parts by weight, respectively, per 100 parts by weight of the polyfunctional acrylate (A).

4. The composition for antistatic hard coat according to claim 1 which is further incorporated with an optional photo-curing agent or radical initiator.

5. An antistatic hard coat formed by setting the composition for antistatic hard coat according to one of claims 1 to 4, wherein the hard coat surface has an elementary composition containing Si at 10 to 35 atomic % on total of Si, C and O.

6. A multilayered film with the antistatic hard coat according to claim 5 which is provided on a base film.

7. The multilayered film with the antistatic hard coat according to claim 6, wherein said base film is coated with an adhesive layer on the side opposite to the antistatic hard coat.

8. The multilayered film with the antistatic hard coat according to claim 7, wherein said adhesive layer is composed of 100 parts by weight of an acrylic polymer and 1 to 20 parts by weight of a silane compound.

9. The multilayered film with the antistatic hard coat according to claim 6 or 7 which has a layer having an additional function as the outermost layer.

10. The multilayered film with the antistatic hard coat according to claim 9, wherein said layer having an additional function is an antireflection film, or IR-cutting or UV-cutting filter.

11. A process for producing an antistatic hard coat which is produced by spreading, drying and setting the composition for antistatic hard coat of one of claims 1 to 4 on a base film, and then is subjected to an optional surface treatment selected from the group consisting of physical treatments by corona discharge, plasma discharge, light from a low-voltage mercury lamp and excimer laser beams, and chemical treatment with an organic solvent to erode the set composition surface and thereby to control Si element content.

12. The process according to claim 11, wherein said composition for antistatic hard coat is set by UV or heat.

13. The process according to claim 11, wherein said surface treatment is effected by corona discharge, plasma discharge or light from a low-voltage mercury lamp.

14. The process according to claim 13, wherein said surface treatment is effected under a pressure near atmospheric pressure, in an air and/or noble gas atmosphere, and in an electrical field having a discharge current density of 0.2 to 300 mA/cm² generated in a pair of counter-electrodes.

15. The process according to claim 14, wherein a pulsed electrical field is applied to the space between a pair of said counter-electrodes to secure the conditions of voltage rise time of 100 μs or less, pulsed electrical field intensity of in a range from 1 to 100 kV/cm and field frequency of 0.5 to 100 kHz.
